(19) United States
(12) Patent Application Publication
(10) Pub. No.: US 2017/0238528 A1
(43) Pub. Date: Aug. 24, 2017

(54) CONTIGUOUS UNI-BODY INSULATED HUNTING BLIND OR OUTDOOR SHELTER

(71) Applicants: Joshua Wilson, Lubbock, TX (US); John Wesley Wilson, Midland, TX (US)

(72) Inventors: Joshua Wilson, Lubbock, TX (US); John Wesley Wilson, Midland, TX (US)

(21) Appl. No.: 15/432,347

(22) Filed: Feb. 14, 2017

Related U.S. Application Data
(60) Provisional application No. 62/297,985, filed on Feb. 22, 2016.

(51) Int. Cl. A01M 31/02; E04B 1/348; E04H 9/14; E04H 1/00; E04H 9/16; E04H 15/00; E04B 1/343

(52) U.S. Cl. CPC A01M 31/025; E04H 15/001; E04H 15/008; E04B 1/348; E04B 1/34336; E04H 1/005; E04H 9/16; E04H 9/145

(57) ABSTRACT

A contiguous uni-body insulated hunting blind or outdoor shelter is disclosed herein. In an embodiment, the shelter is comprised of a main body element having a floor portion and a top portion. The main body element is formed as a single component having an outside layer, a middle layer, and an inner layer. The top portion provides an enclosure for all sides and a top covering. The top portion is also comprised of at least one opening portion and a door opening portion for installing a door for entering and exiting the structure. In embodiments, the top portion is comprised of a top wall, a front wall, a back wall, a left wall, and a right wall with at least one opening portion. In embodiments, the top portion is comprised of one opening portion on each wall except the top wall. In embodiments, the opening portions are configured with windows.

### CROSS-REFERENCE TO RELATED APPLICATIONS

This application claims the benefit under Title 35 United States Code §119(e) of U.S. Provisional Patent Application Ser. No. 62/297,985; Filed: Feb. 22, 2016, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention relates generally to hunting blinds, sport blinds, and outdoor viewing platform structures. More specifically, the present invention relates to such outdoor structures that are constructed as a single component.

### BACKGROUND OF THE INVENTION

Without limiting the scope of the disclosed structure and method, the background is described in connection with an outdoor structure constructed as a single component with insulating properties.

The current state of the art provides for hunting blinds and outdoor structures having various construction types.

As a first example, there are outdoor structures that are assembled parts. That is, the structure can be broken down into modules or parts and then put back together when needed. This approach provides for having to assemble the structure as well as having portions of the structure where crevices or voids are formed. The assembling or disassembling of the structure is a drawback in the time and maintenance it takes to perform those actions as well as the skillset required to perform those actions. The crevices and voids formed are also a drawback in that a big concern with outdoor structures is the infestations of small animals, bugs, and insects within and on the structure.

As a second example, there are outdoor structures that are assembled parts that are not modular and meant to stay together as one piece. These too also have portions of the structure where crevices or voids are formed.

As a third example, there are outdoor structures that have no integrated insulation. Users of these structures either have to dress for the conditions, have some type of insulation added to the structure, or even utilize a heating source. It is ideal to have an outdoor structure that is both thermally insulated, noise insulated, and scent insulated. In hunting applications, all these aspects are highly valued.

As a fourth example, some existing structures in the art are described as uni-body or a single component structure when in fact, they are several components combined to make the structure. Specifically, the walls and roof are separate structures combined to make the structure.

In view of the foregoing, it is apparent that there exists a need in the art for an outdoor structure, which overcomes, mitigates, or solves the above problems in the art. It is the purpose of this invention to fulfill this and other needs in the art, which will become apparent to the skilled artisan once given the following disclosure.

### BRIEF SUMMARY OF THE INVENTION

The present invention, therefore, provides for a single component structure having insulating properties that is used as a hunting blind or outdoor shelter.

In one embodiment, the shelter is comprised of a main body element having a floor portion and a top portion. The main body element is formed as a single component having an outside layer, a middle layer, and an inner layer. The top portion provides an enclosure for all sides and a top covering. In embodiments, the top portion may take many shapes such as but not limited to a square, dome, and rectangle.

The top portion, in embodiments, is also comprised of at least one opening portion, and a door opening portion. The door opening portion for installing a door for entering and exiting the structure.

In embodiments, the top portion is comprised of a top wall, a front wall, a back wall, a left wall, and a right wall with at least one opening portion. In embodiments, the top portion is comprised of one opening portion on each wall except the top wall. In embodiments, the opening portions are configured with windows.

In embodiments, the outer and inner layers are formed out of a rigid material with the middle layer being formed out of an insulating material.

The disclosed invention solves the prior art shortcomings mentioned. It is an object of the invention to provide an outdoor shelter already constructed. It is an object of the invention to provide an outdoor shelter that is already insulated and sealed as to be impenetrable by exterior elements such as weather and pests. It is an object of the invention to provide an outdoor shelter that provides for enhanced noise reduction and scent escape. It is an object of the invention to provide an outdoor shelter that is buoyant.

In summary, the present invention discloses a hunting blind, sport blind, and outdoor viewing platform structure. More specifically, the present invention discloses an outdoor structure that is constructed as a single component having insulating properties.

### BRIEF DESCRIPTION OF THE SEVERAL VIEWS OF THE DRAWINGS

The accompanying drawings, which are incorporated in and form a part of the specification, illustrate a preferred embodiment of the present invention, and together with the description, serve to explain the principles of the invention. It is to be expressly understood that the drawings are for the purpose of illustration and description only and are not intended as a definition of the limits of the invention. In the drawings:

FIG. 1 is a front perspective view of the contiguous uni-body insulated outdoor shelter in accordance with the teachings of the present disclosure;

FIG. 2 is a front view of the contiguous uni-body insulated outdoor shelter in accordance with the teachings of the present disclosure;

FIG. 3 is a back view of the contiguous uni-body insulated outdoor shelter in accordance with the teachings of the present disclosure;

FIG. 4 is a right side view of the contiguous uni-body insulated outdoor shelter in accordance with the teachings of the present disclosure;

FIG. 5 is a left side view of the contiguous uni-body insulated outdoor shelter in accordance with the teachings of the present disclosure;

FIG. 6 is a top view of the contiguous uni-body insulated outdoor shelter in accordance with the teachings of the present disclosure;

FIG. 7 is a bottom view of the contiguous uni-body insulated outdoor shelter in accordance with the teachings of the present disclosure;

FIG. 8 is a front cross sectional view of the contiguous uni-body insulated outdoor shelter in accordance with the teachings of the present disclosure; and

FIG. 9 is a front view of the contiguous uni-body insulated outdoor shelter with the front door open in accordance with the teachings of the present disclosure.

### DETAILED DESCRIPTION OF THE INVENTION

Disclosed herein is a contiguous uni-body insulated outdoor shelter. The numerous innovative teachings of the present invention will be described with particular reference to several embodiments (by way of example, and not of limitation).

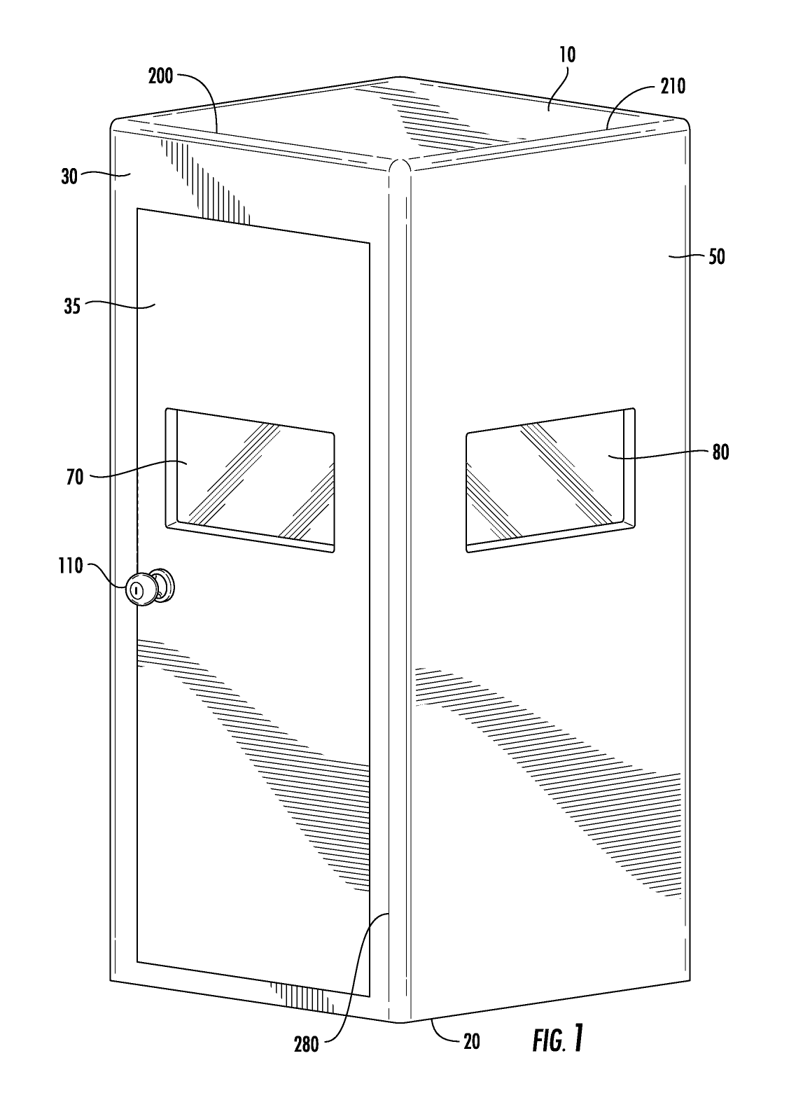

Reference is first made to FIG. 1, a front perspective view of the contiguous uni-body insulated outdoor shelter in accordance with the teachings of the present disclosure. Illustrated here is an embodiment of the shelter in a rectangular form although many forms/shapes may be used. The claimed shelter may be utilized for various activities and applications such as, but not limited to, a hunting blind, outdoor shelter, hunting observations, fishing shelter, and nature observation. In one embodiment, the shelter is comprised of a main body element having a floor portion 20 and a top portion 10, 30, 50. In embodiments, the shelter is comprised of a main body element having a top portion 10, 30, 50 only. That is the shelter does not have a floor. The top portion 10, 30, 50 provides an enclosure for all sides and a top covering. In embodiments, the top portion 10, 30, 50 may take many shapes such as but not limited to a square, dome, and rectangle.

The top portion 10, 30, 50 is also comprised of at least one opening portion 70, 80 and a door opening portion 35 for installing a door 35 for entering and exiting the structure. The opening portions 70,80 are utilized for viewing outside the structure and may be smaller in size than the door opening portion 35. Also illustrated in this figure is the door 35 and door handle 110.

In embodiments, the top portion 30, 50 is comprised of a top wall 10, a front wall 30, a back wall, a left wall, and a right wall 50 with at least one opening portion 70, 80. In embodiments, the top portion 10, 30, 50 is comprised of one opening portion 70, 80 on each wall except the top wall 10. In embodiments, the opening portions 70, 80 are configured with windows.

Also illustrated in this figure, in embodiments, are the corners 200, 210, 280 rounded.

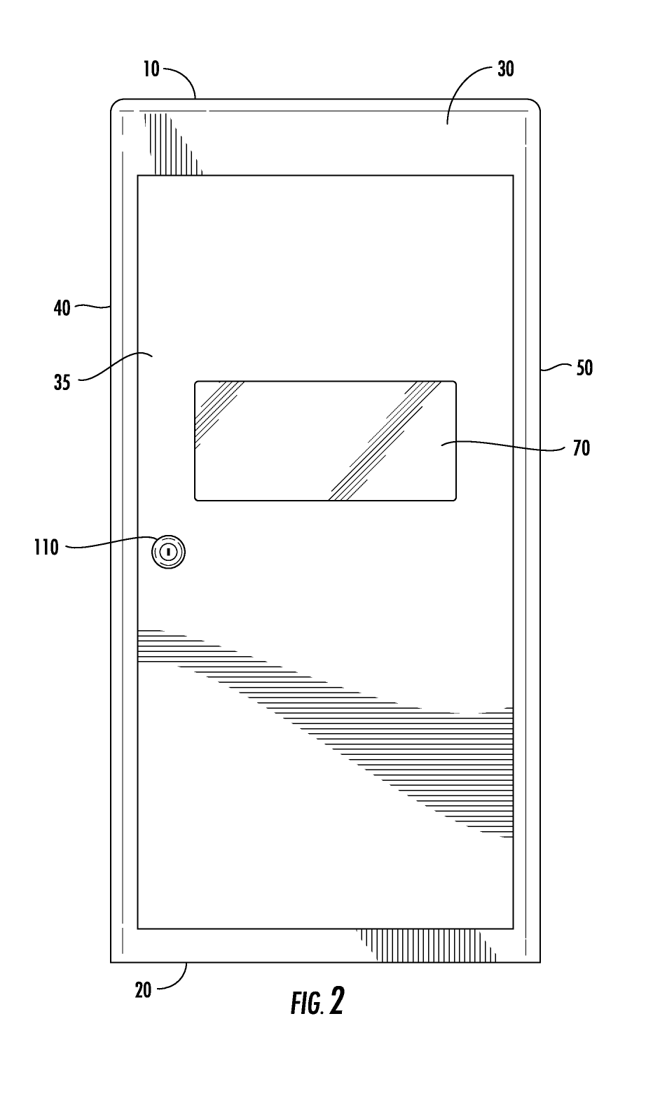

Reference is next made to FIG. 2, a front view of the contiguous uni-body insulated outdoor shelter in accordance with the teachings of the present disclosure. Illustrated in this figure are the door 35, the door handle 110, the front side opening portion 70, the top wall 10, the front side wall 30, the left side wall 40, the right side wall 50, and the floor portion 20.

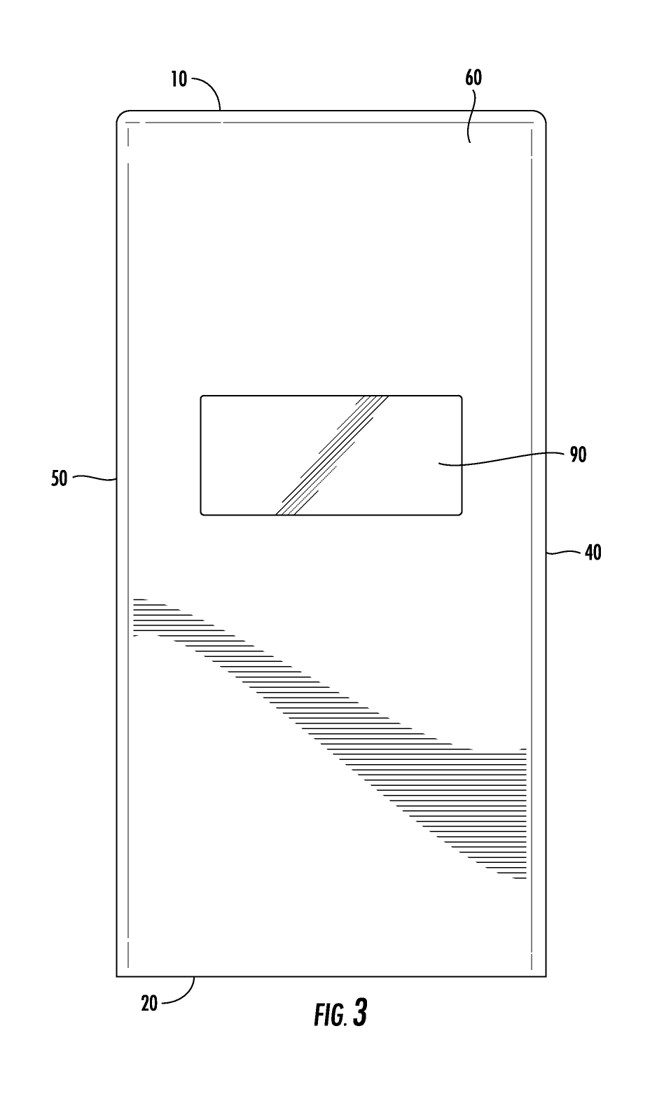

Reference is now made to FIG. 3, a back view of the contiguous uni-body insulated outdoor shelter in accordance with the teachings of the present disclosure. Illustrated in this figure are the back side opening portion 90, the back side wall 60, the top wall 10, the left side wall 40, the right side wall 50, and the floor portion 20.

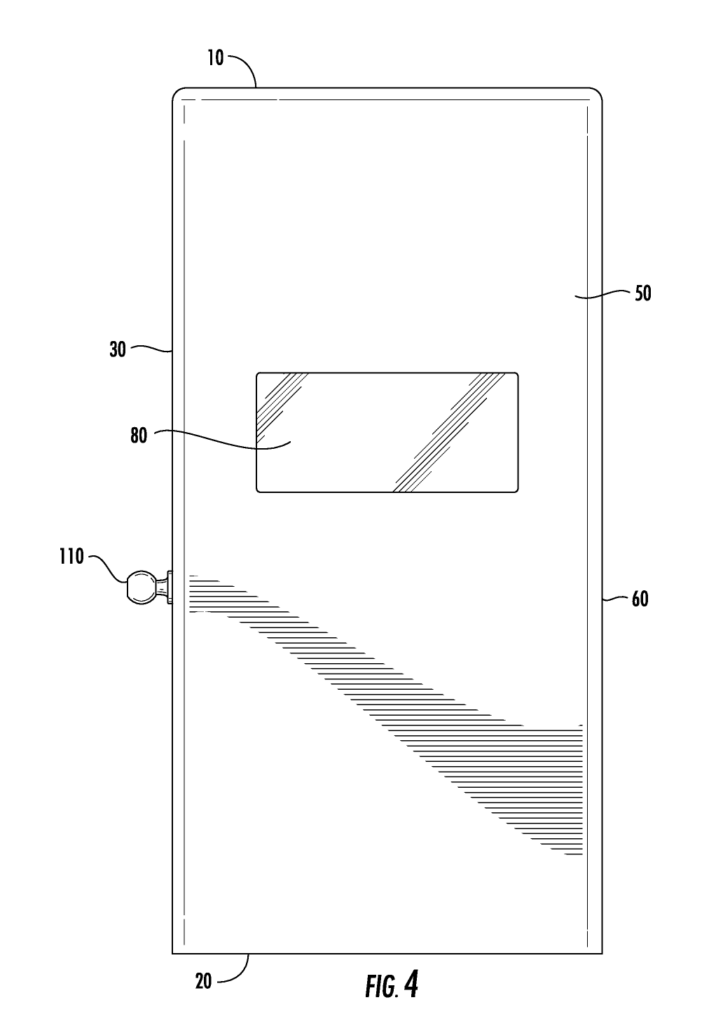

Reference is next made to FIG. 4, a right side view of the contiguous uni-body insulated outdoor shelter in accordance with the teachings of the present disclosure. Illustrated in this figure are the right side opening portion 80, right side wall 50, the top wall 10, the front side wall 30, the back side wall 60, the door handle 110, and the floor portion 20.

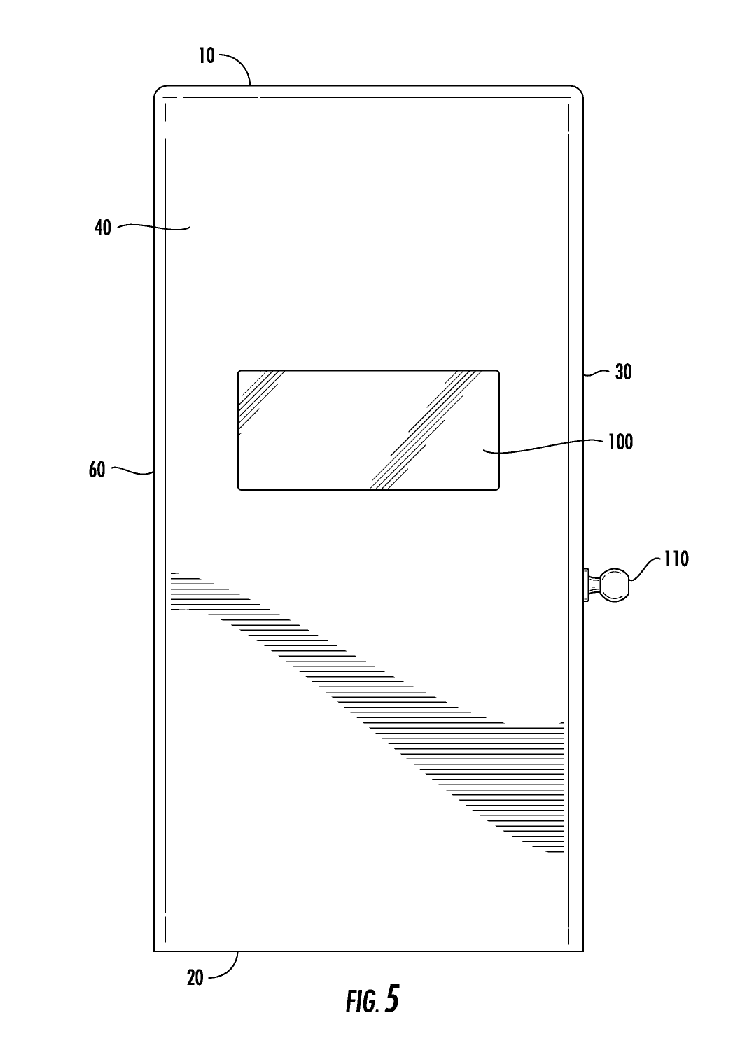

Reference is now made to FIG. 5, a left side view of the contiguous uni-body insulated outdoor shelter in accordance with the teachings of the present disclosure. Illustrated in this figure are the left side opening portion 100, left side wall 40, the top wall 10, the front side wall 30, the back side wall 60, the door handle 110, and the floor portion 20.

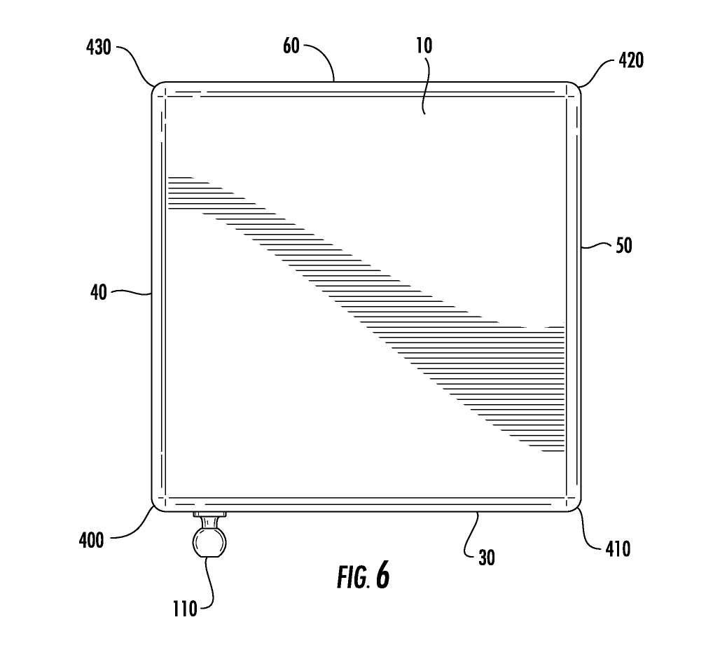

Reference is next made to FIG. 6, a top view of the contiguous uni-body insulated outdoor shelter in accordance with the teachings of the present disclosure. Illustrated in this figure are the top side wall 10, the front side wall 30, the back side wall 60, the left side wall 40, the right side wall 50, and the door handle 110. Also seen in this figure are the rounded corners 400, 410, 420, 430 in an embodiment of the shelter.

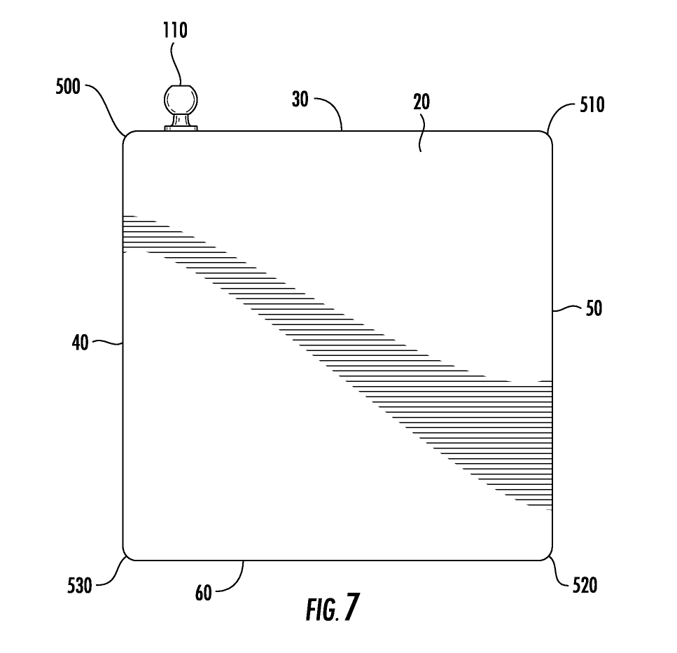

Reference is now made to FIG. 7, a bottom view of the contiguous uni-body insulated outdoor shelter in accordance with the teachings of the present disclosure. Illustrated in this figure are the floor portion 20, the front side wall 30, the back side wall 60, the left side wall 40, the right side wall 50, and the door handle 110. Also seen in this figure are the rounded corners 500, 510, 520, 530 in an embodiment of the shelter.

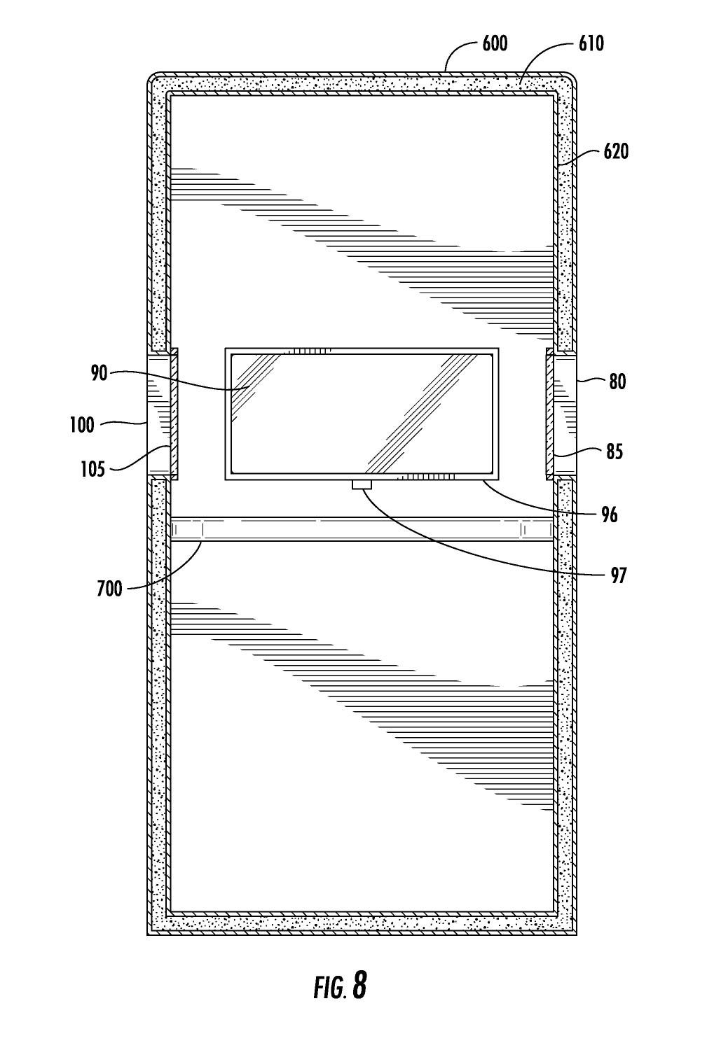

Reference is next made to FIG. 8, a front cross sectional view of the contiguous uni-body insulated outdoor shelter in accordance with the teachings of the present disclosure.

The main body element is formed as a single uni-body component having an outside layer 600, a middle layer 610, and an inner layer 620. The outer layer 600 and inner layer 620 are contiguous and seamless to each other, encapsulating the middle layer 610. That is, the outer layer 600 and inner layer 620 form one contiguous and seamless structure comprising the main body element having a floor portion 20 and a top portion 10, 30, 40, 50, 60. The encapsulated middle layer 610 is also one piece and not formed by combining multiple pieces.

In embodiments, the outer 600 and inner 620 layers are formed out of a rigid material with the middle layer 610 being formed out of an insulating material. In embodiments the outer 600 and inner 620 layers are made from, as an example and not a limitation, a polymer. In embodiments, the outer 600 and inner 620 layers are made from polyethylene, PVC, nylons, or polypropylene. In embodiments, the middle layer 610 is made from, as an example and not a limitation, a foam material.

In embodiments, the outer 600 and inner 620 layers have a thickness between ⅛ inch and ¼ inch. In embodiments, the middle layer 610 has a thickness between 1 inch and 1¾ inch.

Because of the lightweight materials used including the insulating foam material as the middle layer 610, the contiguous uni-body insulated outdoor shelter has buoyant properties inherent in the structure such that the structure will float in water. In addition, due to the contiguous uni-body insulated design, the structure also has thermal insulating, noise insulating, and scent insulating properties.

Also illustrated in this figure are the left side open portion 90, the right side open portion 80, the back side open portion 90, the left side open portion glass 105, the right side open portion glass 85, the back side open portion glass 90, the back side open portion glass frame 96, the back side open portion glass open/close tab 97, and an installed/added interior counter 700.

As illustrated, the structure may also be comprised of glass windows 90, 96 97, screens, or similar structures for closing or covering the open portions 70, 80, 90, 100.

An example is provided next of one approach, as an example and not a limitation, for building, constructing, or forming the contiguous uni-body insulated hunting blind or outdoor shelter.

### EXAMPLE 1

Use of a Rotational Molding System Known in the Art
Step 1: Plastic resin powder that has been pre-weighted to meet the specifications of the shelter along with a chemical foaming agent (CFA) are loaded into the mold cavity and then securely closed within the mold. The chemical foaming agent produces a wide range of foam densities and wall thicknesses, maintains more uniform wall thickness, achieves increased wall thickness at reduced weight ratios, achieves full dispersal of the CFA for a consistent high-quality cell structure and improves physical properties of the molded part and yields lighter more buoyant parts with better insulating properties.
Step 2: The mold then moves from the loading station into the heating station and is rotated both on the horizontal and vertical axis.
Step 3: The mold is then heated to the specific temperature the shelter requires and the plastic resin powder liquefies uniformly covering the inner lining of the mold.
Step 4: Once the heating stage is completed the mold then moves to the cooling station.
Step 5: The mold is cooled for a predetermined set time to cure the shelter in the mold.
Step 6: Once the cooling stage is completed the product is then removed from the mold and the process is repeated.
Step 7: Once the shelter has been produced, the shelter is then trimmed, routed and processed in order to configure the opening portions 70, 80, 90, 100 and the door opening portion 35.
Step 8: The process is then repeated with the addition of plastic resin powder that has been preweighted to meet the specifications of the shelter in order to complete the inner layer and connecting the inner and outer layer to fully encapsulate the true uni-body insulated core. This process would also be used to create the insulated door for the blind that may also include an opening portion 70.

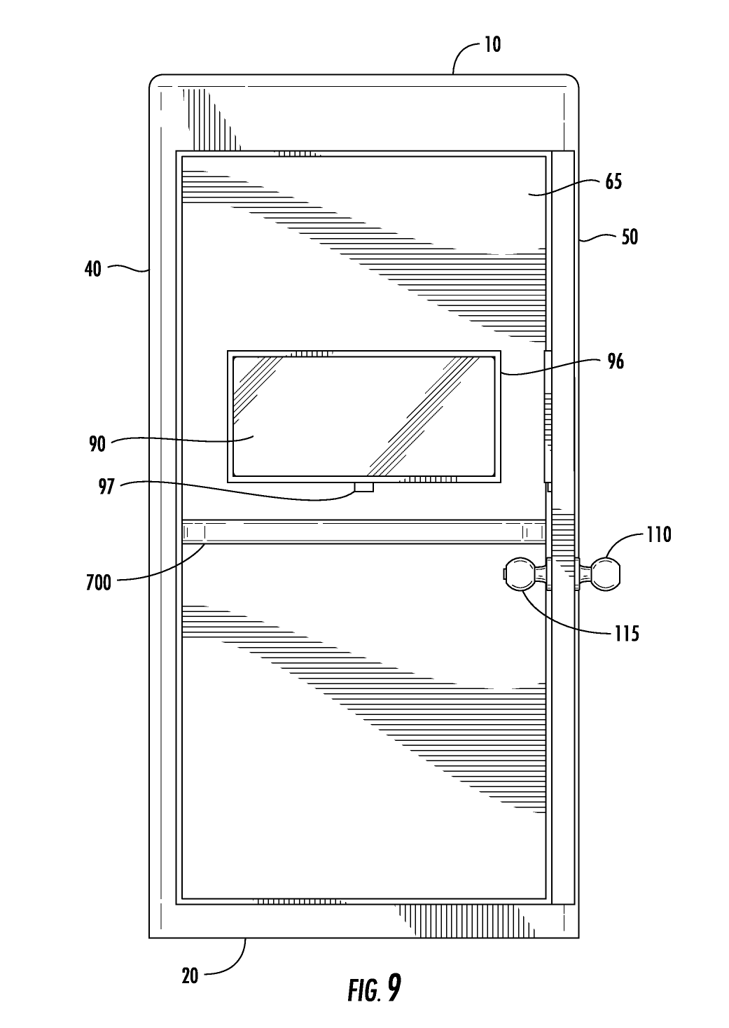

Reference is lastly made to FIG. 9, a front view of the contiguous uni-body insulated outdoor shelter with the front door open in accordance with the teachings of the present disclosure. Illustrated in this figure are the inside door handle 115 and the inside of the back side wall 65.

The disclosed structures and methods are generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed structure or method, except as may be outlined in the claims.

Any embodiments comprising a one piece or multi piece structure having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific structures and methods described herein. Such equivalents are considered to be within the scope of this invention and are covered by the claims.

All publications, references, patents, and patent applications mentioned in the specification are indicative of the level of those skilled in the art to which this invention pertains. All publications, references, patents, and patent applications are herein incorporated by reference to the same extent as if each individual publication, reference, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The structures and/or methods disclosed and claimed herein can be made and executed without undue experimentation in light of the present disclosure. While the structure and methods of this invention have been described in terms of preferred embodiments, it will be apparent to those skilled in the art that variations may be applied to the structures and/or methods and in the steps or in the sequence of steps of the methods described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A uni-body outdoor shelter comprising:
a main body element;
said main body element comprised of an outside layer, a middle layer, and an inner layer all forming a floor portion and a top portion;
wherein said top portion is comprised of an opening portion and a door opening portion;
and wherein said outside and inner layer are contiguous and seamless to each other and encapsulate the one piece middle layer.

2. A uni-body outdoor shelter comprising:
a main body element;
said main body element comprised of an outside layer, a middle layer, and an inner layer all forming a top portion;
wherein said top portion is comprised of an opening portion and a door opening portion;
and wherein said outside and inner layer are contiguous and seamless to each other and encapsulate the one piece middle layer.

3. The outdoor shelter of claim 1, wherein said top portion is square shaped.

4. The outdoor shelter of claim 1, wherein said top portion is dome shaped.

5. The outdoor shelter of claim 1, wherein said top portion is comprised of a top wall, a front wall, a back wall, a left wall, and a right wall.

6. The outdoor shelter of claim 5, wherein said front wall is comprised of a door opening portion and said left wall, right wall, and back wall each is comprised of an opening portion.

7. The outdoor shelter of claim 1, wherein said middle layer is an insulating material.

8. The outdoor shelter of claim 1, wherein said outside and inner layers are rigid materials.

9. The outdoor shelter of claim 1, wherein said middle layer is an insulating material and said outside and inner layers are rigid materials.

10. The outdoor shelter of claim 6, wherein said middle layer is an insulating material and said outside and inner layers are rigid materials.

11. The outdoor shelter of claim 7, wherein said insulating material is foam.

12. The outdoor shelter of claim 8, wherein said rigid material is from the group consisting of polymer, polyethylene, pvc, nylons, and polypropylene.

13. The outdoor shelter of claim 1, wherein said outer and inner layers are ⅛ inch to a ¼ inch thick and said middle layer is 1 inch to 1¾ inch thick.

14. The outdoor shelter of claim 9, wherein said outer and inner layers are ⅛ inch to a ¼ inch thick and said middle layer is 1 inch to 1¾ inch thick.

15. The outdoor shelter of claim 1, further comprising a door having an opening portion.

16. The outdoor shelter of claim 1, further comprising an interior counter.

17. The outdoor shelter of claim 1, further comprising windows within each opening portion.

18. The outdoor shelter of claim 9, wherein said shelter is buoyant enough to float in water.

19. The outdoor shelter of claim 14, wherein said shelter is buoyant enough to float in water.

20. A uni-body outdoor shelter comprising:
a main body element;
said main body element comprised of an outside layer, a middle layer, and an inner layer all forming a floor portion and a top portion;
wherein said top portion is comprised of an opening portion and a door opening portion;
wherein said outside and inner layer are contiguous and seamless to each other and encapsulate the one piece middle layer;
wherein said top portion is square shaped;
wherein said top portion is comprised of a top wall, a front wall, a back wall, a left wall, and a right wall;
wherein said front wall is comprised of a door opening portion and said left wall, right wall, and back wall each is comprised of an opening portion;
wherein said middle layer is an insulating material and said outside and inner layers are rigid materials;
wherein said outer and inner layers are ⅛ inch to a ¼ inch thick and said middle layer is 1 inch to 1¾ inch thick;
further comprising a door having an opening portion;
further comprising an interior counter;
further comprising windows within each opening portion; and
wherein said shelter is buoyant enough to float in water.
